(19) United States
(12) Patent Application Publication
(10) Pub. No.: US 2023/0139831 A1
(43) Pub. Date: May 4, 2023

(54) SYSTEMS AND METHODS FOR INFORMATION RETRIEVAL AND EXTRACTION

(71) Applicant: DataInfoCom USA, Inc., Austin, TX (US)

(72) Inventors: Wensu Wang, Katy, TX (US); Kuikui Gao, Houston, TX (US); Yuhao Sun, Plano, TX (US); Hao Peng, Fulshear, TX (US)

(21) Appl. No.: 17/491,361

(22) Filed: Sep. 30, 2021

Related U.S. Application Data
(60) Provisional application No. 63/085,963, filed on Sep. 30, 2020.

(51) Int. Cl. G06F 16/33; G06F 40/40; G06V 30/14

(52) U.S. Cl. CPC G06F 16/3344; G06F 40/40; G06V 30/1444

(57) ABSTRACT

To extract necessary information, documents are received, converted to text, and stored in a database. A request for information is then received, and relevant documents and/or document passages are selected from the stored documents. The needed information is then extracted from the relevant documents. The various processes use one or more artificial intelligence (AI), image processing, and/or natural language processing (NLP) techniques.

### CROSS-REFERENCE TO RELATED APPLICATIONS

The present application claims the benefit of U.S. Provisional Patent Application No. 63/085,963, filed Sep. 30, 2020, which is incorporated by reference herein in its entirety.

### BACKGROUND

This specification generally relates to extracting information from documents and more specifically to using image processing, natural language processing, and artificial intelligence techniques to convert any type of document to a computer-readable digital form (e.g., table, form, text, pdf, image, etc.) and extract needed information from it.

### SUMMARY

In accordance with the foregoing objectives and others, exemplary methods and systems are disclosed herein for retrieving and extracting information from documents. Documents are received, converted to text, and stored in a database. A request for information is then received, and relevant documents and/or document passages are selected from the stored documents. The needed information is then extracted from the relevant documents. The various processes use one or more artificial intelligence (AI), image processing, and/or natural language processing (NLP) techniques.

An embodiment comprises a method for extracting information from a computer-readable digital document, comprising: converting the document to an image; segregating the converted image into segments; identifying segments that contain needed information; classifying the identified segments into machine-typed or handwritten text; converting each segment of the document into a digital text format using one of a trained machine learning model or an optical character recognition algorithm; and extracting information from the converted text.

Another embodiment comprises a system for retrieving data from a database of documents, the system comprising: a data storage engine configured to store documents in the database; a document conversion engine configured to convert the documents in the database to text; an information retrieval engine configured to retrieve documents in the database based on at least one natural language processing (NLP) technique; and an information extraction engine configured to extract information from the retrieved documents and supply the extracted information as the retrieved data.

Another embodiment comprises a question answering method used for information extraction, comprising: receiving a type of needed information; converting the type of needed information to a question; searching for at least one passage relevant to the question in at least one relevant document; and extracting at least one answer from the found passages.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for information retrieval and information extraction.

FIG. 2 illustrates an example information retrieval and information extraction system.

FIG. 3 illustrates an example method for information retrieval and information extraction.

FIG. 4 illustrates an image file consisting of machine-printed text.

FIG. 5 illustrates an image file consisting of hand-written text.

FIG. 6 illustrates an image file with both machine-printed and hand-written text.

FIG. 7 illustrates an example method for converting images of text (either handwritten or machine-typed) into text.

FIG. 8 illustrates an example of an image of machine-typed text.

FIG. 9 illustrates a machine-typed text image after a filter is applied.

FIG. 10 illustrates segmentation of a filtered image of text.

FIG. 11 illustrates an embodiment of a handwriting recognition model.

FIG. 12 illustrates an embodiment of a text classification model.

FIG. 13 illustrates an example conversion of an image to text.

FIG. 14 illustrates an example method for information retrieval using a question and answer framework.

### DETAILED DESCRIPTION

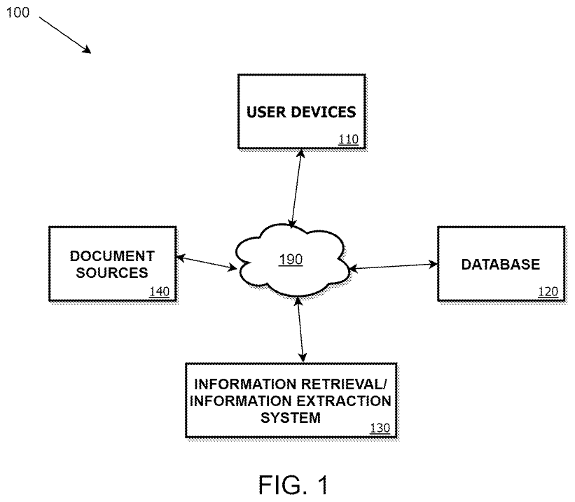

Referring to FIG. 1, a block diagram of an exemplary system 100 for use in information retrieval and information extraction is illustrated. The information retrieval system may include user devices 110, a database 120, an information retrieval and information extraction (IR/IE) system 130, and may receive input from document sources 140. The user devices, database, IR/IE system, internal devices, and external devices may be remote from each other and interact through communication network 190. Non-limiting examples of communication networks include local area networks (LANs), wide area networks (WANs) (e.g., the Internet), etc.

In certain embodiments, a user may access the information retrieval system 130, database 120, and/or document sources 140 via a user device 110 connected to the network 190. A user device 110 may be any computer device capable of accessing any relevant resource, system, or database, such as by running a client application or other software, like a web browser or web-browser-like application.

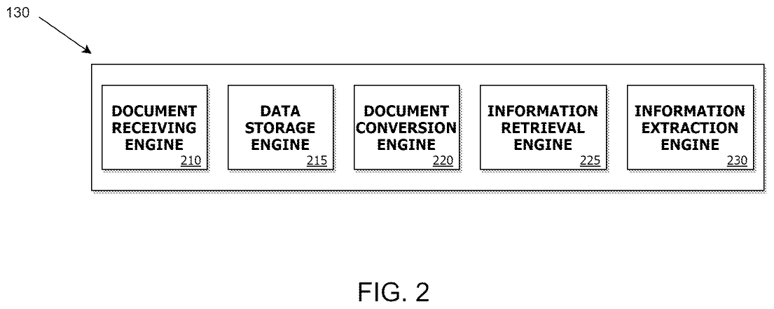

The information retrieval and information extraction system 130 is adapted to receive documents from document sources 140 and retrieve documents from database 120, convert received or retrieved documents to text (or another common format), and extract information from the converted documents. FIG. 2 is a more detailed schematic illustration of one example of an information retrieval and extraction system 130. As illustrated, the information retrieval and information extraction system may include a document receiving engine 210, a data storage engine 215, a document conversion engine 220, an information retrieval engine 225, and an information extraction engine 230. These engines are configured to communicate with each other to manage the entire process of receiving documents, data storage, document conversion, information retrieval, and information extraction.

Document receiving engine 210 is configured to receive documents of any sort from document sources 140. Documents received may include text documents, word processing documents, pdf documents, images, and scanned documents, including scanned machine-typed (i.e., machine-printed) documents, scanned handwritten documents, and scanned documents with a mix of machine-typed and handwritten content.

Data storage engine 215 is configured to store the documents received by document receiving engine 210 into database 120. Data storage engine 215 is also configured to store documents converted by document conversion engine 220 and outputs from information retrieved and extracted from documents by information retrieval engine 225 and information extraction engine 230 into database 120. Data storage engine 215 can also be configured to store data in either structured or unstructured format, or both, depending on the type of documents and data received from document receiving engine 210.

Document conversion engine 220 is configured to convert documents into a form that is interpretable by the information retrieval and information extraction engines. In an embodiment, all documents are converted, through one or more processes, to text format. For example, a pdf document may be converted to text by extracting the embedded format structure of text objects or by converting the document to images then using optical character recognition (OCR) techniques. Similarly, a scanned machine-typed document in image format may be converted to text using OCR techniques or other image processing as well as AI techniques.

Handwritten documents may be converted to text using deep learning and/or machine learning techniques to build a handwriting recognition model, e.g., comprising one or more trained neural networks. For documents containing both machine-typed/machine-printed portions and handwritten portions, in one embodiment the machine-typed and handwritten contents are segmented, and then processed separately using machine learning models trained to recognize each different kind of writing (e.g., hand-written, machine typed, etc.). Alternatively, the trained models for separate kinds of writing may be integrated as one model (e.g., they may be combined in series or in parallel) or may be used to train a unified text recognition model. For example, one specific way the trained models could be integrated is to create a top layer that identifies the type of writing present, hand-written or machine-typed, then sends the image segments to the appropriate model.

In an embodiment, a document can be segmented into several portions and then each portion converted to text, respectively. Segmenting can be performed using one or more techniques, alone or in combination. For example, a list of keywords based on domain knowledge can be created and used to identify the start or end of a segment, such as segments in an individual tax return form. The converted texts can then be compared with these keywords to determine the start or end of a segment using a similarity measure between the keywords and the words of the document.

In an embodiment, a set of blank horizontal whitespace or blank vertical whitespace can be used to identify the start or end of a segment.

In an embodiment, a line or row with a specified characteristic, e.g., a text format, a specific combination or distribution of types of characters, etc., may be identified as the start or end of a segment. For example, a row containing all words without numbers may be identified as a header of an embedded table in the converted document. The successive rows with another specified text format, such as containing mixed words and numbers, may be identified as the contents of the table until the second format is not present in the next row.

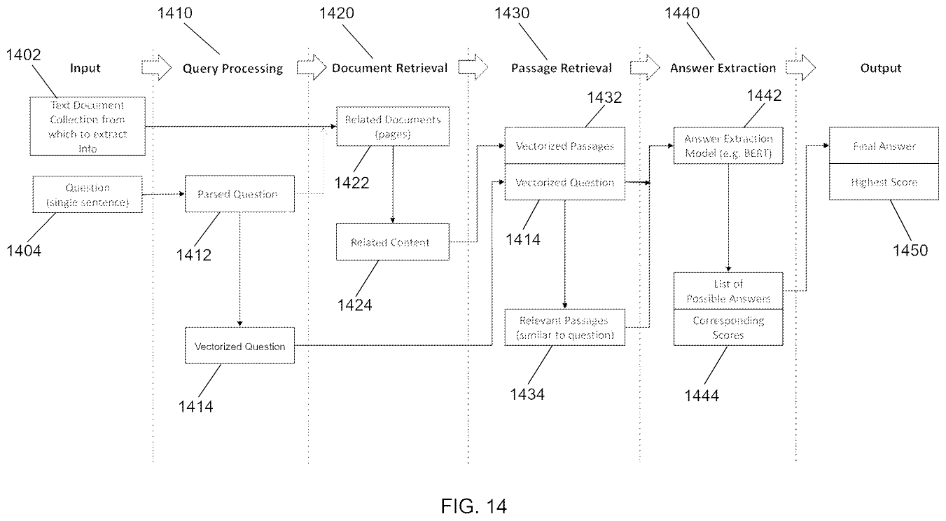

In an embodiment, a question answering technique may be used to identify segments. An example of a question-and-answer system is described with respect to FIG. 14.

In all document conversion techniques for documents with a visual aspect (e.g., images, pdf files, scanned document, word processing document, etc.), the positional relationships of the converted segments can be maintained, e.g., using x and y coordinates. This retains useful context information, which can be used by the information extraction engine 230

Documents converted by the document conversion engine 220 also include audio and video files, e.g., audio recordings of phone calls, video recordings of video calls, video chats, etc. After documents are converted to the desired format, e.g., text format, relevant information can be retrieved by the information retrieval engine 225 and extracted by the information extraction engine 230.

Information retrieval engine 225 is configured to search for all converted-to-text documents and/or document segments that are related to the information to be extracted. The methods used for information retrieval can be knowledge-based (e.g., if financial information is needed, documents containing solely medical information, such as doctor's notes, do not need to be retrieved, but tax return documents would be retrieved), rule-based (e.g., identifying documents based on a pre-defined set of rules), keyword-based (e.g., identifying documents based on keyword matching), machine-learning model-based (e.g., using a trained neural network to identify documents), among other possibilities.

In an embodiment, a transfer learning model, based on pre-trained information retrieval, can be used to efficiently build a retrieval model for document retrieval from a customized document database.

Information extraction engine 230 uses natural language processing (NLP) techniques to extract the required information from the converted-to-text documents selected by information retrieval engine 225. Such techniques may include text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, trained or pre-trained transfer learning, question-and-answer systems, etc.

Knowledge-based methods can also be used for information extraction from specific types of documents. For example, for an individual tax return form, first the form can be segmented into several parts based on keywords present in the document for each section, and then every item in each section is converted to text and compared with pre-defined keywords that are required to be extracted, and items are selected as intended information based on the comparison result. The comparison can include various text analytic and neutral language processing methods, such as to compare characters in the words or the semantic meaning of the words.

The extracted information can be associated with a confidence score. The score may be calculated in various ways depending on the type of model. Some types of models automatically output confidence scores with the extracted information. Alternatively, a probability value, similarity score, and/or a precision value may be returned with the extracted information.

To improve the accuracy of information extraction, human intervention can be integrated within the information extraction process when necessary. For example, whenever the confidence score is low, human intervention may be requested, which allows a person to validate and update the result. A low confidence level can also be associated with a message indicating the reason for the low confidence (e.g., 1) incomplete or missing information; 2) inconsistent information; 3) unclear information; and/or 4) calculation verification required, etc.), allowing the person to identify the specific reason for the low confidence level. Any human input back to the information extraction engine can be used as a labeled data point to re-train it and improve its accuracy.

Modifications, additions, or omissions may be made to the above systems without departing from the scope of the disclosure. Furthermore, one or more components of the systems may be separated, combined, and/or eliminated. Additionally, any system may have fewer (or more) components and/or engines. Furthermore, one or more actions performed by a component/engine of a system may be described herein as being performed by the respective system. In such an example, the respective system may be using that particular component/engine to perform the action.

As mentioned above, the system is able to automatically extract information from documents using document conversion engine 220, information retrieval engine 225, and information extraction engine 230. Information may be extracted in various ways, depending on the type of document and the specific information needed. Documents may include pdf documents (e.g., filled pdf forms, pdf text documents (including tax return forms, insurance policy documents, and books), handwritten pdf documents, etc.), text documents, scanned images (e.g., of text documents, machine-typed documents, receipts, manually-filled out forms, and other handwritten documents, such as doctors' notes, etc.), program-generated images, audio and/or video recordings of phone and/or video calls, etc.

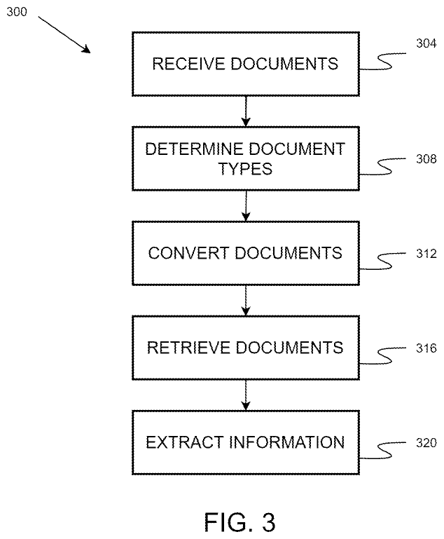

A method 300 for information extraction is illustrated in FIG. 3. In step 304, a set of initial document files is received. The system also receives an indication of the information to be extracted from the document. In step 308, the types of the documents (e.g., pdf or image file) are determined.

In step 312, the documents are converted to text using one or more techniques as described herein, e.g., using document conversion engine 220. In step 316, relevant documents are selected, e.g., using document retrieval engine 225.

In step 320, the needed information is extracted from the retrieved documents using natural language processing (NLP), including text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, transfer learning, question-and-answer methods, etc. The information extraction may be performed by information extraction engine 230.

With respect to step 312 and document conversion engine 220, how a document is converted to text depends on its type. Pdf documents may be converted to text, and processed as a text document by the information extraction engine 230. Some pdfs in standard format may be directly converted to text using a pdf conversion package. In an embodiment, standard pdf documents that include tables may first be segregated into table-containing parts and other parts (e.g., through identification of table-related tags), and the parts converted to text separately. The tables may be converted into a text table format (e.g., a CSV file) using a table conversion package.

In cases where the pdf document is unable to be converted to text directly (e.g., the pdf does not follow ISO or other standards or it is a wrapper for images), the pdf may be transformed into one or more image files and processed as such.

The document conversion engine 220 is also configured to convert image files to text.

Any image file format (e.g., jpeg, png, gif, bmp, tiff, etc.), including image file formats that will be created in the future, may be converted using this method.

An image file may also be segmented, a region of interest (ROI) can be selected first and then only the ROIs are converted to text to be used for information extraction.

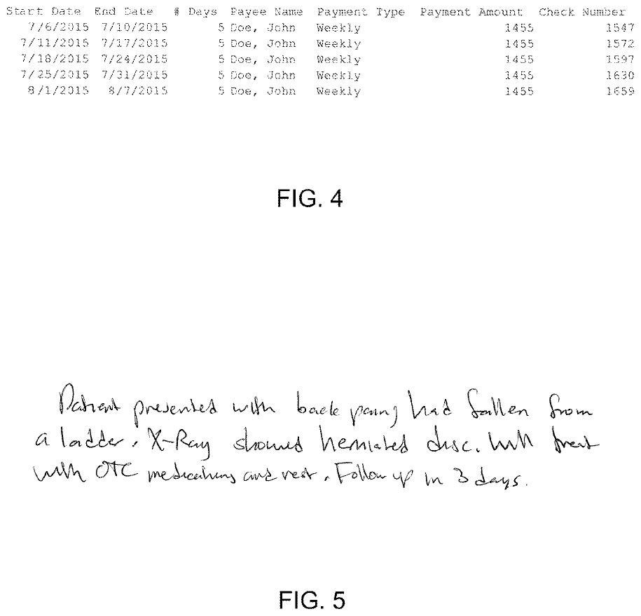

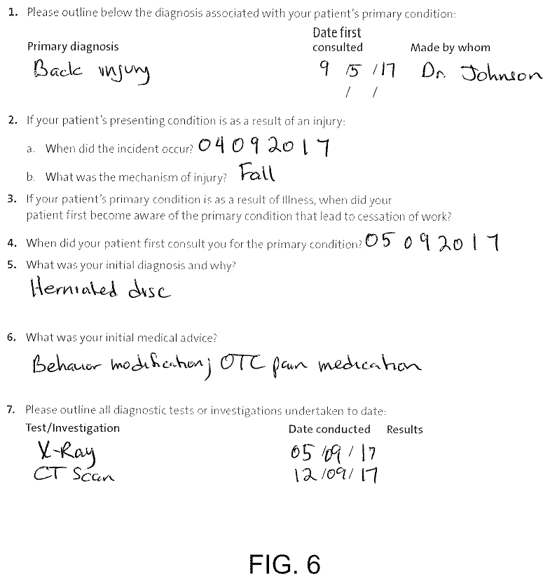

Image files documents may be generally divided into three categories: 1) image files consisting of machine-printed or machine-typed text (see FIG. 4); 2) image files consisting of hand-written text (see FIGS. 5); and 3) image files with both (see FIG. 6).

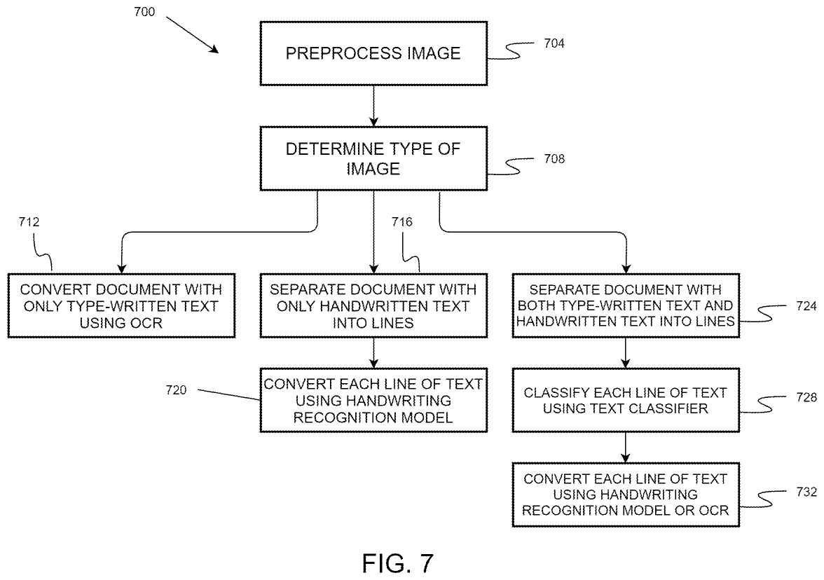

A method for converting images of text (either handwritten or machine-typed) into text is illustrated in FIG. 7. In step 704, images may be preprocessed, using techniques including skew correction, perspective transformation, and/or noise removal.

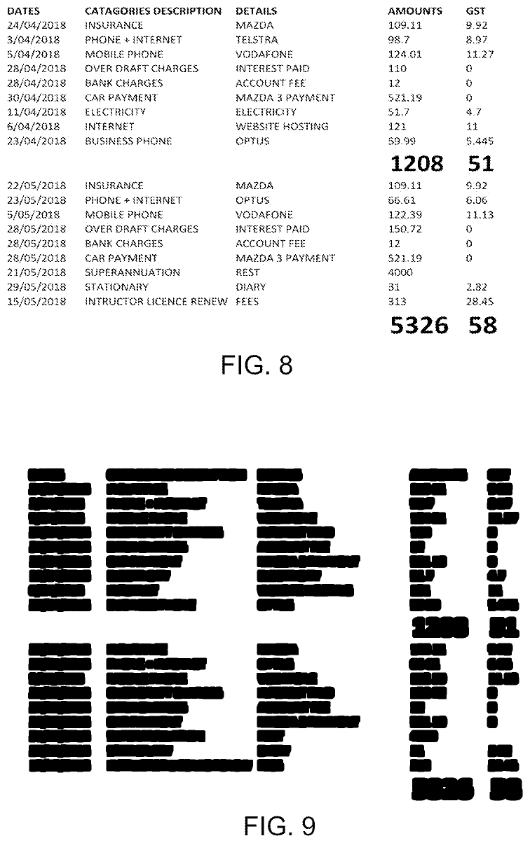

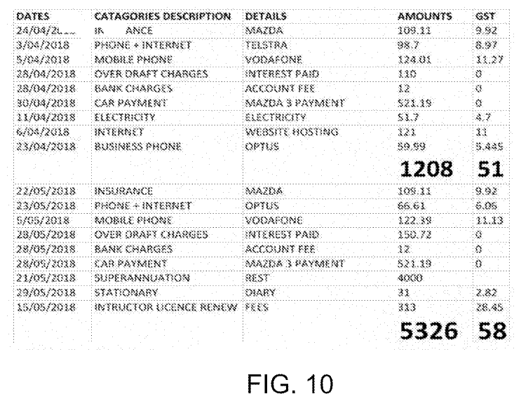

Images may also have morphological transformations applied to them to better identify segments of text, including dilation, erosion, opening (erosion followed by dilation), closing (dilation followed by erosion), etc. An example of how these transformations can help identify segments of text is shown in FIGS. 8 through 10. FIG. 8 is an example of machine-typed text. FIG. 9 shows the image after a dilation or erosion filter is applied several times, and the lines of text have been converted into more easily separable patches of black vs. white. The individual lines of text can then be segmented, as is shown in FIG. 10.

In step 708, the type of image is determined, e.g., if the image is solely machine-typed text, solely handwritten text, or a combination. In an embodiment, a deep learning classifier may be used to initially classify image files into one of the three categories. Alternatively, such classification may be performed manually.

If the image includes only machine-printed text, it is converted to text using OCR in step 712. The resulting text document may then be processed by the information retrieval engine 225 and the information extraction engine 230. Tables in the image may be separately identified and processed by OCR techniques that preserve the table structure during the conversion to text.

If the image includes only handwritten text, it is converted to text using a trained deep learning model, which may be trained at the text line, word, or character level or other granular level, such as segments. In an embodiment, the deep learning handwriting recognition model comprises a convolutional neural network (CNN) connected to a recurrent neural network (RNN), which is in turn connected to a connectionist temporal classification (CTC) scoring function. The CNN is trained to extract a feature sequence, such as a text line, from the image. The RNN propagates the information from the CNN through the feature sequence, and the CTC classifies the output character. The output of the trained handwriting recognition model is a sequence of identified characters. The handwriting recognition model can be trained using tagged handwriting line samples or other granular levels.

To process an image containing handwritten characters, the document conversion engine 220 first separates the handwriting into lines of text in step 716, as illustrated in FIGS. 8 through 10.

In step 720, each line of handwritten text is converted to text using the trained deep learning model. The resulting text can then be processed by the information extraction engine 230.

Documents that include both machine-typed text and handwritten text, e.g., manually filled-out forms (see FIG. 6), are commonly used in many industries. Such forms often include a series of questions or other machine-typed labels for needed information, and spaces in which to write the supplied information. To automatically process such a form, the document conversion engine 220 uses a text classifier that recognizes typed and handwritten text in a mixed image. In an embodiment, the classifier is a trained deep learning model that classifies text lines into machine-printed text lines and handwritten text lines. In a particular embodiment, the deep learning model may comprise a convolutional recurrent neural network. The model may be trained on labeled printed and handwritten text lines.

To process an image containing both machine-typed and handwritten characters, the document conversion engine 220 first separates the document into lines of text in step 724, using the techniques described herein (e.g., with respect to step 716). In step 728, each line of text is classified by the text classifier into either a line of machine-typed text or a line of handwritten text.

In step 732, each line of text is converted to text using appropriate methods, e.g., OCR for printed text, and the trained handwriting recognition model for handwritten text. The resulting text can then be processed by the information extraction engine 230.

For the images that are converted to text format, positional relationships between the original image of the text and the converted text may also be stored. For example, the original location of each text segment in the document may be stored (e.g., using x and y coordinates) along with the converted text. This enables proximity and/or context information to be used by the information extraction engine 230 when extracting needed information from the document.

If the image is unable to be converted to text, e.g., it is unreadable, it contains handwritten characters that overlay with others, etc., the image can be flagged for human intervention.

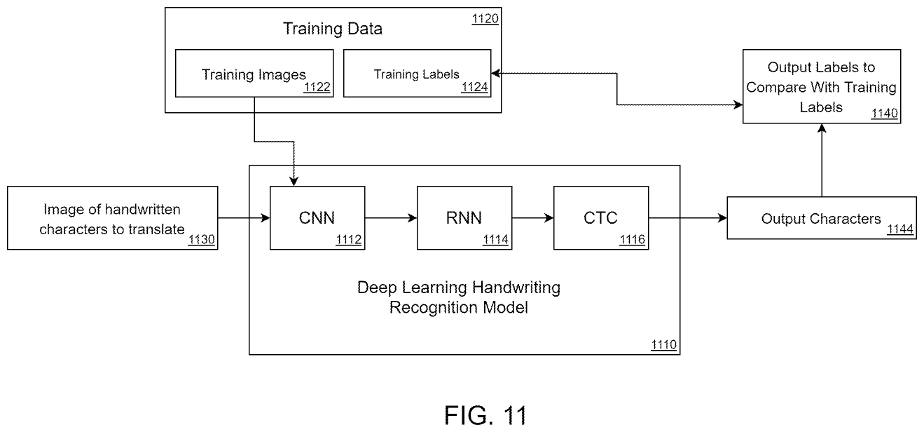

FIG. 11 illustrates an embodiment of the handwriting recognition model 1110. This embodiment comprises a convolutional neural network (CNN) 1112 connected to a recurrent neural network (RNN) 1114, which is in turn connected to a connectionist temporal classifier (CTC) 1116.

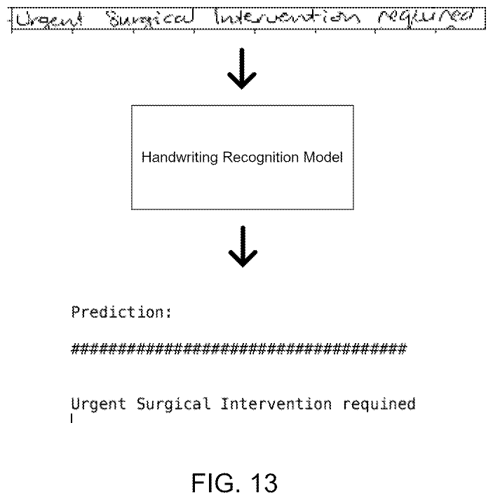

The model is trained using labeled training data 1120, including training images of handwritten text 1122 and labels for the training images 1124. During training, the images are processed through the model 1110, and then the output of the model 1140 is compared with the training labels 1124. The loss is then backpropagated through the network to tune the network weights. After the model is trained, an image 1130, containing a line of handwritten characters, may be processed through the model 1110 to generate output characters 1144. An example of conversion is illustrated in FIG. 13.

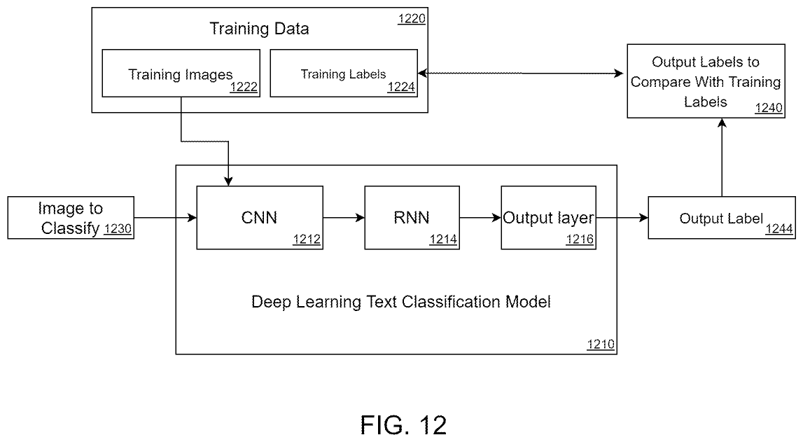

FIG. 12 illustrates an embodiment of the text classification model. This embodiment comprises a convolutional neural network (CNN) 1212 connected to a recurrent neural network (RNN) 1214, which is connected to an output layer 1216, such as a Softmax layer.

The model is trained using labeled training data 1220, including training images of handwritten and machine-typed text 1222 that are labeled accordingly 1224. During training, the images are processed through the model 1210, and then the output of the model 1240, e.g., whether the input image is handwritten or machine-typed, is compared with the training labels 1224. The loss is then backpropagated through the network to tune the network weights. After the model is trained, an image 1230, containing either a line of handwritten characters or a line of machine-typed characters, may be processed through the model 1210 to be classified.

After the document(s) is converted to text, the information extraction engine 230 uses

NLP techniques to extract the needed information. Such techniques may include text normalization (e.g., converting to a consistent case, removing stop words, lemmatizing, stemming, etc.), keyword recognition, part of speech tagging, named entity recognition (NER), sentence parsing, regular expression searching, word chunk searching (e.g., using a context-free grammar (CFG)), similarity searching (e.g., with word/sentence embedding), machine learning models, transfer learning with pre-trained models, question and answer systems, etc.

For example, in an image document with form format, the words of the questions (or other labels) may be parsed using NLP techniques to identify where in the form the needed information may be found.

After the location of the question (or label) for the needed information is identified, the location of the answer is determined. This will generally be in proximity to the question or label, e.g., for forms, it will generally be underneath the question (or label) or to the right of the question. The stored line locations (e.g., x and y coordinates) can be used to identify lines of text in close proximity to the question or label, as such lines are more likely to include the information for the data point. In some instances, the lines containing a possible answer will be underlined, or surrounded by a box. The converted text of the lines in proximity may then be analyzed to determine the value of the data point.

As a specific example, if a date is required, e.g., the date of injury, the incurred data, the date of a doctor's diagnosis, etc., words indicating a date may be identified in the form. Such words include, for example, ‘date’, ‘when’, etc. The type of date may also be identified via keywords such as ‘injury’ for date of injury, etc.

After it is determined that the needed date is in the document, the actual information, e.g., the value for the date, is identified using NLP techniques. Because the context of each line of text is saved (e.g., its position in the document), the system can search for dates in nearby text. For example, text in date format near the words indicating the date may be identified and used as the value of the data point.

Another technique that may be used for information retrieval and extraction is question-and-answer. An example method 1400 using a question-and-answer framework is illustrated in FIG. 14. The method takes a pre-defined input question crafted for the required data point 1402 and a collection of text documents 1404 from which to extract the data point required to answer the question. The method comprises four main phases: 1) query processing; 2) document retrieval; 3) passage retrieval; and 4) answer extraction, which leads to an output answer.

In the query processing phase 1410, the input question 1402 is parsed to remove stop words and particular parts of speech, leaving only the most important words of the query.

In an embodiment, only proper nouns, nouns, numbers, verbs, and adjectives are kept from the original query, resulting in a parsed question 1412. Also in this phase, the query is converted into a vector (1414) for use later in the process.

In an alternative embodiment, the input to the method may be the desired information, instead of an actual question. In this embodiment, the input information is first translated into a question before the query processing phase.

The next phase 1420 after the query processing phase involves document retrieval using the parsed query. The query is sent to the document collection, and a set of related documents 1422 is returned. Afterwards, the relevant documents are fetched from the database to retrieve all related content 1424.

After the related documents are retrieved, they are converted into a set of passages (a passage is a shorter section of a document) for faster processing in phase 1430. This can be performed by a passage model trained with e.g., coordinate and text data. The passages are converted to vectors (1432), then compared with the vectorized query (1414) to identify the passages most similar to the query, using cosine similarity or another similarity measure.

The most similar passages 1434, and the vectorized question 1414, are then input into an answer extraction model 1442 (such as BERT (Bidirectional Encoder Representations from Transformers)) in the answer extraction phase 1440. The output of the model is the possible answers, each with a corresponding confidence score (1444). The answer with the highest score 1450 can be the final output of the method.

### Use Cases

The disclosed systems and method for information retrieval and information extraction may be used in a variety of industries. One use case for the insurance industry is extracting insurance policy rules, conditions, data points, and/or formulae from insurance policy documents.

Insurance policy documents are typically machine-typed text documents, such as pdf files. As such, they are readily converted to text using the techniques described herein. Furthermore, insurance policy documents usually have identifiable section headings and/or a table of contents, so the policies are able to be segregated based on the chapter titles and/or section headings. For example, if the policy document includes sections with headings including the terms “Total disability” and “Partial disability,” the system segregates the policy document based on those headings.

After the policy document is segregated, the individual sections may be processed using the information extraction techniques described herein. Through these techniques, all benefit items are extracted for each policy. Then, for each benefit item, the following are extracted: 1) benefit conditions in order to qualify for the benefit; 2) data points that define the benefit items; and 3) the actual benefits, e.g., a monetary amount specified in the policy document, a monetary amount calculation formula, variables, and/or non-monetary benefits.

For example, an example policy clause may read:

We will pay up to $100 per day for up to 90 days for each day the immediate family member has to stay away from home after the end of the waiting period.

The system uses the NLP techniques to parse this clause to identify several important data points, including: 1) per diem amount (e.g., $100); 2) maximum time period (e.g., 90 days); 3) qualified payee (e.g., immediate family member); and 4) qualified action (e.g., stay away from home).

In another example, the text of the policy document may recite:

The person insured is totally disabled if, because of an injury or sickness, he or she is: 1) not capable of doing the important duties of his or her occupation; 2) not working in any occupation (whether paid or unpaid); and 3) under medical care.

The uses the NLP techniques to parse this clause and determine 4 requirements for a benefit: 1) the claimant is not capable of doing the important duties of his or her occupation; 2) this condition is because of an injury or sickness; 3) the claimant is not working in any occupation; and 4) the claimant is under medical care.

For example, the system can determine that the requirement of “injury or sickness” exists because of the presence of the keywords “injury” and/or “sickness” in the clause.

Similarly, “under medical care” indicates the requirement of being under medical care, “not working” indicates the requirement of not working in any occupation, and “not capable” indicates the requirement of not being capable of doing the important duties of his or her occupation.

Another use case is comparison of insurance policies and identification of similar insurance policies. After the benefit information (e.g., benefit conditions, data points, actual benefits, etc.) are extracted from the insurance policy documents, the benefit information of two policies may be compared. Both the extracted structured information and the policy text itself may be compared to make a determination as to how similar the policies are. The policy text may be compared using NLP similarity techniques (e.g., cosine similarity, etc.). Comparisons between an original policy and several alternative polices may be calculated to determine a closest match.

Another use case for the insurance industry is the extraction of information from insurance claim documents. Claim documents may include pdf documents (e.g., filled pdf forms, pdf text documents (including tax returns and policy documents), handwritten pdf documents, etc.), text documents, scanned images (e.g., of text documents, machine-typed documents, receipts, manually-filled out forms, and other handwritten documents, such as doctors' notes, etc.) and/or program-generated images. Such documents may be converted to text using the methods described herein, and then processed using NLP information extraction techniques.

For each claim, there are questions that need to be answered in order to process the claim, e.g., “what is the incurred date?” and “is the claimant under medical care?” The answers to these questions can be automatically extracted from applicable claim documents.

The first step in answering a question is to identify the types of documents that may include an answer to the question. For example, for the “what is the incurred date?” question, relevant documents may include claim forms, doctors' medical opinions, clinical notes, transcripts of phone calls regarding the claim, transcripts of phone calls with the employer, etc.

After the documents that may answer the question are identified, the system then processes each document using NLP techniques to determine if the question is answered in the document. In an embodiment, NLP techniques are used to determine if the subject of the question is discussed in the document.

For example, in a form, the words of the questions (or other labels) may be parsed using

NLP techniques to identify where in the form the needed information may be found. If a date is required, e.g., the incurred date, the date of a doctor's diagnosis, etc., words indicating a date may be identified in the form. Such words include, for example, ‘date’, ‘when’, etc. The type of date may also be identified via keywords such as ‘injury’ for date of injury, ‘incurred’ for incurred date, etc.

If it is determined that the subject of the question is discussed in the document, the answer to the question is identified using NLP techniques. Because the context of each line of text is saved (e.g., its position in the document), the system can search for answers to the question in nearby text. For example, if the answer to the question is a date, text in date format near the words indicating the date may be identified and used as the answer to the questions.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a non-transitory medium for execution by a data processing apparatus. The computer storage medium can be one or more of: a machine-readable storage device, a machine-readable storage substrate, a random or serial access memory device, and combinations thereof.

As used herein, the term “data processing apparatus” comprises all kinds of apparatuses, devices, and machines for processing data, including but not limited to, a programmable processor, a computer, and/or multiple processors or computers. Exemplary apparatuses may include special purpose logic circuitry, such as a field programmable gate array (“FPGA”) and/or an application specific integrated circuit (“ASIC”). In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any programming language, and it can be deployed in any form, including as a standalone program or as a module, component, subroutine, or other unit suitable for use in a computing environment. A computer program can be deployed and/or executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a random access memory (“RAM”).

Computer readable media suitable for storing computer program instructions and data include all forms of nonvolatile memory, media, and memory devices. For example, computer readable media may include one or more of the following: semiconductor memory devices, such as ROM or RAM; flash memory devices; magnetic disks; magneto optical disks; and/or CD-ROM and DVD-ROM disks. The processor and the memory can be supplemented by, or incorporated in, special purpose logic circuitry.

To provide for interaction with a user, embodiments may be implemented on a computer having any type of display device for displaying information to a user. Exemplary display devices include, but are not limited to one or more of: projectors, cathode ray tube (“CRT”) monitors, liquid crystal displays (“LCD”), light-emitting diode (“LED”) monitors, and/or organic light-emitting diode (“OLED”) monitors. The computer may further comprise one or more input devices by which the user can provide input to the computer. Input devices may comprise one or more of: keyboards, pointing devices (e.g., mice, trackballs, etc.), and/or touch screens. Moreover, feedback may be provided to the user via any form of sensory feedback (e.g., visual feedback, auditory feedback, or tactile feedback). A computer can interact with a user by sending documents to and receiving documents from a device that is used by the user (e.g., by sending web pages to a web browser on a user's client device in response to requests received from the web browser).

Embodiments of the subject matter described in this specification can be implemented in a computing system that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Non-limiting examples of communication networks include a local area network (“LAN”) and a wide area network (“WAN”), e.g., the Internet.

The computing system may include clients and/or servers, including servers managing a web API. The client and server may be remote from each other and interact through a communication network. The relationship of client and server arises by virtue of computer programs running on the respective computers and having a client-server relationship to each other.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A method for extracting information from a computer-readable digital document, comprising:
converting the document to an image;
segregating the converted image into segments;
identifying segments that contain needed information;
classifying the identified segments into machine-typed or handwritten text;
converting each segment of the document into a digital text format using one of a trained machine learning model or an optical character recognition algorithm; and
extracting information from the converted text.

2. The method of claim 1, wherein extracting information is done using at least one natural language processing technique.

3. The method of claim 1, wherein extracting information is based on spatial coordinates of text on the image.

4. The method of claim 1, wherein extracting information is done using a question answering system.

5. The method of claim 1, wherein each segment comprises one or more lines of text.

6. The method of claim 1, wherein segregating an image into segments uses a set of received keywords to identify the start or the end of a segment, wherein the identification comprises using a similarity measure between the keywords and the words of the document.

7. The method of claim 1, wherein segregating an image into segments uses a blank horizontal space or a blank vertical space to identify the start or the end of a segment.

8. The method of claim 1, wherein segregating an image into segments comprises using a row with a specified characteristics as the start of a segment.

9. The method of claim 1, wherein segregating an image into segments comprises a question-answering technique.

10. The method of claim 1, wherein the conversion of segments to a digital text format uses a trained handwriting recognition model for handwritten text, and an optical character recognition algorithm for machine-typed text.

11. The method of claim 1, wherein the conversion of segments to a digital text format uses a trained unified text recognition model for both handwritten text and machine-typed text.

12. A system for retrieving data from a database of documents, the system comprising:
a data storage engine configured to store documents in the database;
a document conversion engine configured to convert the documents in the database to text;
an information retrieval engine configured to retrieve documents in the database based on at least one natural language processing (NLP) technique; and
an information extraction engine configured to extract information from the retrieved documents and supply the extracted information as the retrieved data.

13. The system of claim 12, wherein the document conversion engine is configured to convert pdf documents to text.

14. The system of claim 12, wherein the document conversion engine is configured to convert pdf documents to images.

15. The system of claim 12, wherein the document conversion engine is configured to convert image documents to text.

16. The system of claim 15, wherein the conversion of image documents to text uses a trained handwriting recognition model for handwritten text, and an optical character recognition algorithm for machine-typed text.

17. The system of claim 16, wherein the conversion of image documents to text further uses a trained model to distinguish between handwritten text and machine-typed text.

18. The system of claim 15, wherein the conversion of image documents to text uses a trained unified text recognition model for both handwritten text and machine-typed text.

19. The system of claim 12, wherein the document conversion engine is configured to convert documents that include tables to text.

20. The system of claim 12, wherein the document conversion engine is configured to convert documents that include multiple columns to text.

21. The system of claim 12, wherein the information retrieval engine uses one or more of knowledge-based techniques, rule-based techniques, keyword-based techniques, and deep-learning NLP model based techniques.

22. The system of claim 12, wherein the information extraction engine uses one or more of knowledge-based techniques, rule-based techniques, keyword-based techniques, and deep-learning NLP model based techniques.

23. The system of claim 12, wherein the information extraction engine is configured to receive a set of keywords, compare the keywords with the text from the converted documents using a similarity measure to identify matching portions of text, and select the matching portions of text as the extracted information.

24. The system of claim 24, wherein the information extraction engine is further configured to calculate a confidence score for each matching portion of text.

25. The system of claim 25, wherein the information extraction engine is further configured to flag retrieved data for further review when the confidence score is below a threshold.

26. A question answering method used for information extraction, comprising:
receiving a type of needed information;
converting the type of needed information to a question;
searching for at least one passage relevant to the question in at least one relevant document; and
extracting at least one answer from the found passages.

27. The method of claim 26, wherein the searching comprises converting the question to a vector in an embedded semantic space;

28. The method of claim 27, wherein the searching comprises comparing the vectorized question to a set of vectorized document passages using a similarity measure.
